(19) United States
(12) Patent Application Publication
(10) Pub. No.: US 2010/0044257 A1
(43) Pub. Date: Feb. 25, 2010

(54) PACKAGE FOR CDS AND ALIKE

(75) Inventor: Allan Morton, Queensland (AU)

Correspondence Address: MERCHANT & GOULD PC, P.O. BOX 2903, MINNEAPOLIS, MN, 55402-0903, US

(73) Assignee: MEDIA TECHNOLOGY PTY LTD., NEW SOUTH WALES (AU)

(21) Appl. No.: 11/722,471

(22) PCT Filed: Dec. 23, 2004
(86) PCT No.: PCT/AU04/01843

§ 371 Date: May 30, 2008

(51) Int. Cl. B65D 85/30; B05D 5/00; C09D 133/08; G11B 33/04

(52) U.S. Cl. 206/308.1; 427/256; 427/288; 524/531

(57) ABSTRACT

The present invention relates to a package for mailing CDs, DVDs or other optical computer readable mediums made of materials that include polycarbonate. The package includes a panel, preferably made of paperboard material, against which a surface of the optical computer readable medium can be located to protect against damage during mailing. The panel has a coating applied thereto that has a hardness that is less than the hardness of the polycarbonate material from which the optical computer medium is made in order to prevent the panel from scratching the surface of the optical computer readable medium. Although the coating may be in any form, it is preferred that the coating include an acrylic polymeric material.

### FIELD AND BACKGROUND OF THE PRESENT INVENTION

The present invention relates to a package suitable for mailing CDs, DVDs and other optical computer readable medium such as Super Density Compact Disks (SDCDs) and HybridDVDs.

Generally speaking packages for mailing CDs and other optical computer readable medium are designed to withstand stresses applied by high speed sorting machinery and prevent damage to the optical computer readable medium while being mailed. Handling the package by high speed sorting machinery and transporting the package from one location to another invariably causes the CD to move at least to some extent despite the packages being carefully designed to prevent such movement.

In addition, CDs, DVDs and other optical computer readable medium are normally made of materials that include polycarbonate, which, compared to paperboard and most other packaging materials, is relatively soft.

As a result, a difficulty that can be encountered with some packages is that the optical computer readable medium is susceptible to scratching caused by relative movement between the optical computer readable medium and the packaging material during sorting and transportation.

The scratches sustained may not only detract from the visual appearance of the optical computer readable medium, but can also inhibit the ability to read information from a readable surface of the optical computer readable medium which is normally smooth and shiny.

It is therefore an object of the present invention to provide an alternative package suitable for mailing optical computer readable mediums.

### SUMMARY OF THE INVENTION

According to the present invention there is provided a package for mailing CDs, DVDs or other optical computer readable mediums made of materials that include polycarbonate, the package including a panel against which a surface of the optical computer readable medium can be located to protect against damage during mailing, and wherein the panel has a coating applied thereto that has a hardness that is less than the hardness of the polycarbonate material from which the optical computer medium is made in order to prevent the panel from scratching the surface of the optical computer readable medium.

It is preferred that the surface of the optical computer readable medium be one or a combination of a readable surface or an opposite surface on which information is usually printed.

It is preferred that the coating applied to the panel include an acrylic polymeric material.

It is also preferred that the acrylic polymeric material include constituents that influence any one or a combination of: i) the softness of the coating; and ii) friction between the coating and the optical computer readable medium.

It is preferred that the frictional characteristics between the coating and a CD or alike be at least in part influenced by the amount of silicon in the coating.

The coating may be cured using any suitable method, however according to one embodiment, it is preferred that the coating be curable by ultra violet (UV) light.

In the instance when the coating is in the form a acrylic polymeric material that is UV light curable, it is preferred that the coating have the following composition:

| CONSTITUENT | MASS PERCENTAGE (%) |
|---|---|
| Multifunctional acrylic oligomers | 25-35 |
| Acrylated modified epoxy | 20-30 |
| Acrylated silicone | 1-3 |
| Petroleum wax dispersion | 10-20 |
| Other constituents | 44-12 |

It is preferred that the coating be applied to the panel of the package using known printing techniques.

In order for the coating to be applied using printing techniques, the coating before being cured, must have a suitable viscosity. Our research has established that an aqueous dispersion of the coating having viscosity properties suitable for printing can be obtained when the acrylated modified epoxy constituent mention in the table above is substituted with a styrenated acrylic dispersion.

Having now discussed the nature of the coating in more detail, other preferred aspects relating to the structure and mode of manufacture of the package will now be discussed.

For instance, although it is possible that the panel to which the coating is applied may be made of any suitable material include thermosetting and thermoplastic resins, it is preferred that the panel be made of a paperboard material. An advantage provided by paperboard is that it is a low cost material that can be cut and folded into a package that can be mailed.

Moreover, the package may have any suitable shape and configuration for receiving a CD or alike optical computer readable medium. For example, the package may consist solely of a single panel having slots and notches designed to receive the edges of an optical computer readable medium in order to retain the medium to the package. In this instance, the single panel may be mailed by itself or alternatively, the single panel can be placed inside a separate envelope corresponding to the size of the panel.

Another example is that the package may be in the form of a pocket, satchel, wallet or an envelope.

In the instance when the package is a wallet or envelope, it is preferred that the package have at least two interconnected panels, whereby a readable surface of the optical computer readable medium can be located against one of the panels and the opposite side of the optical computer readable medium can be located against one of the other panels.

When the package includes two or more panels that contact both sides of the CD or alike, it is preferred that the coating be applied to both panels against which the surface of the CD or other computer readable medium can be located.

Moreover the package may, for example, have the shape and configuration of any one of the designs illustrated in our Australian design applications and registrations of a CD wallet blank. Details of our design applications and registrations are as follows and are hereby incorporated into this patent specification.

| Australian design applications | Australian design registrations |
|---|---|
| 3380/03 | 147943 |
| 3381/03 | 147944 |
| 3382/03 | |
| 3383/03 | |
| 3384/03 | |
| 3385/03 | |

According to the present invention there is provided a method for making a package for mailing CDs, DVDs or other optical computer readable mediums made of materials that include polycarbonate, the package including a panel against which a surface of the optical computer readable medium can be located to protect against damage during mailing, and wherein the method includes applying a coating that when cured has a hardness that is less than the hardness of the polycarbonate material from which the optical computer readable medium is made in order to prevent the panel from scratching the optical computer readable medium.

The method of the invention may also include any one or a combination of the preferred features of the package of the invention described above. For example, it is preferred that the method includes applying the coating using a known printing technique.

In the instance in which the package is made from a paperboard material that is made with a grain direction, and the panel of the package on which the coating is applied includes one or more retaining slots that can receive edges of the optical computer readable medium for holding the optical computer readable medium to the panel, it is preferred that the method includes cutting at least part of the slots in a direction that is substantially parallel to the direction of the grain of the paperboard. An advantage provided by this preferred aspect is that the cuts will not tend to have burrs caused by cutting.

According to the present invention there is also provided a coating material that can be applied to a panel of a package for mailing CDs, DVDs or other computer readable medium made of polycarbonate material, the coating when applied and cured on the panel has a hardness that is less than the hardness of the polycarbonate material from which the optical computer readable medium is made, such that coating can prevent scratching a surface of the optical computer readable medium, wherein the coating material has any one or a combination of the features of the coating described above.

### BRIEF DESCRIPTION OF DRAWINGS

Three alternative embodiments of a package of the present invention will now be described with reference to the accompanying drawings, of which:

FIG. 1 is a CD wallet blank according to a first embodiment and is the subject matter of Australian design registration no. 147944;

FIG. 2 is a CD wallet blank according to a second embodiment and is the subject matter of Australian design registration no. 147943;

FIG. 3 is a CD wallet blank according to a third embodiment and is the subject matter of Australian design application no. 3383/2003; and

FIG. 4 is a CD wallet blank according to a fourth embodiment and is the subject matter of Australian design application no. 3385/2003.

### DETAILED DESCRIPTION OF PREFERRED EMBODIMENT

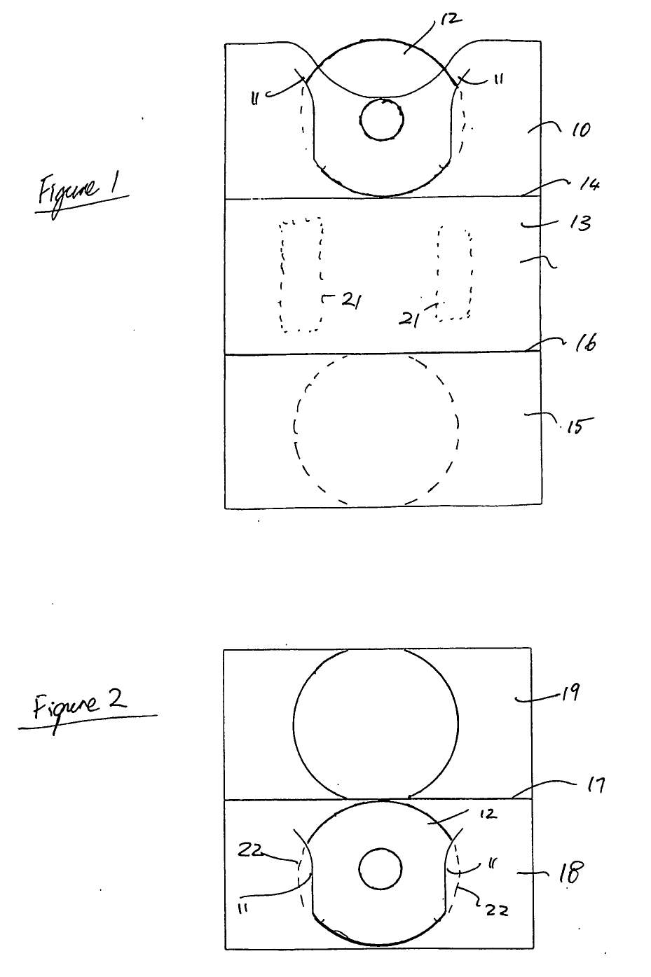

FIGS. 1 to 4 illustrate four CD wallet blanks than can be folded to form packages for mailing CDs and other optical computer readable mediums. The three embodiments shown in FIGS. 1 to 3 each include a number of identical or similar features and the same reference numerals have been used to identify the same features on the different embodiments where possible.

It will be appreciated that the package of the present invention is by no means limited to the CD wallets shown in the figures.

For instance, the package of the present invention may be in any suitable form having a panel on which the CD or other optical computer readable medium can be located to protect the CD or alike during mailing. More particularly, the package may be in the form of a pocket or satchel comprising two rectangular shaped panels that are interconnected along three sides to form a cavity in which the CD or alike can be located.

Each of the CD wallet blanks shown in the figures comprise two or more paperboard panels interconnected by fold lines. Paperboard has been chosen as the preferred material of construction because it is a low cost material that can be used in high-speed production processes. Paperboard is also preferred for several other reasons including biodegradability and printability.

In the case of FIG. 1, the CD wallet blank comprises three panels namely a front panel 10 having slots 11 for receiving and retaining a CD 12 to a front face of the panel 10, a second intermediate panel 13 connected by a fold line 14 to the front panel 10 and a third panel 15 interconnected to the intermediate panel 13 by a fold line 16. When assembled, the intermediate panel is folded backwards and glued to the back face of the front panel 10 such that the third panel forms a flap that can then be folded downwardly over the front face of the front panel 10 and thereby form a closeable wallet.

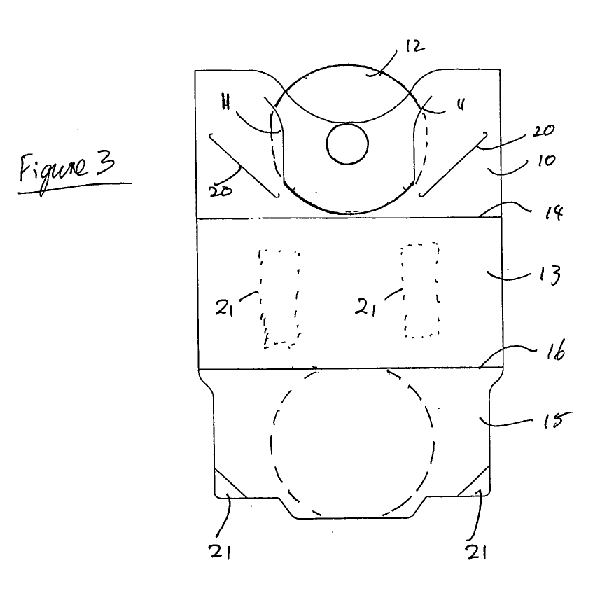

FIG. 2 illustrates an embodiment of a CD wallet blank comprising two panels interconnected by a fold line 17 in which one panel 18 comprises a pair of slots 11 for receiving the edges of the CD 12 to hold and secure the CD 12 to the front face of the panel 18. In use, the opposite panel 19 can then be folded over the front face to close the CD wallet. A disadvantage with this design of CD wallet is that that the edges of the CD protruding through the slots 11 are not contained within the envelope.

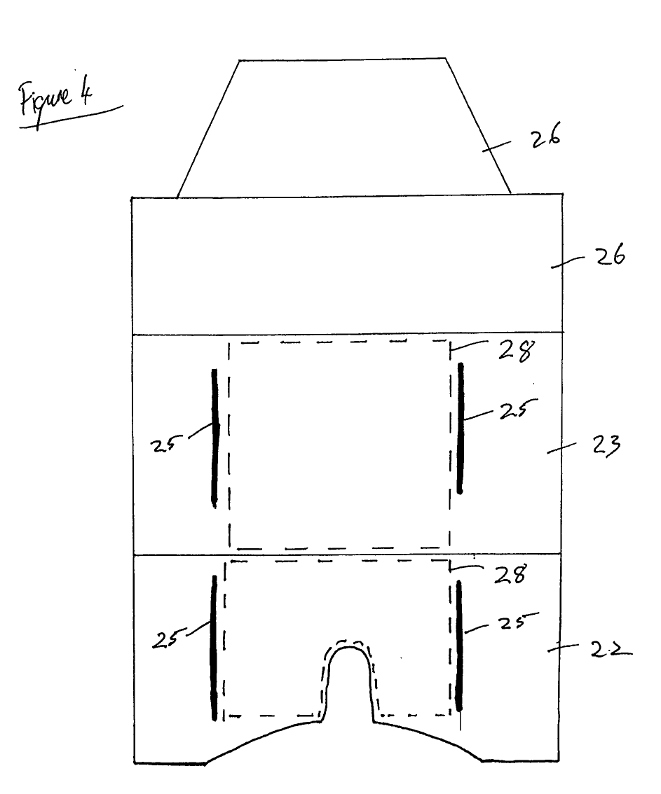

The blank shown in FIG. 3 is substantially the same as the blank shown in FIG. 1, however, the front face of the front panel 10 includes an additional set of slots 20 that are designed to receive the lower corners 21 of the flap in order to hold the flap in a closed folded position.

Despite the three CD wallet blanks being specifically designed for mailing CDs or alike, it is possible for the CDs to be scratched by moving within each package. This problem has at least to a large extent been overcome by applying a coating to the package that has a hardness that is less than the hardness of the polycarbonate material from which CDs or alike may be made.

Specifically, in the case of the embodiment shown in FIGS. 1 and 3, the coating material is applied to a region of the front face of the front panel 10 that would be covered by the CD 12. The coating material may also be applied to the back face of the front panel 10 that would be contacted by the edges of the CD when received in the slots 11. In addition, the coating may also be applied in a circular shape to a back face of the flap 15 which would come into contact with the front face of the CD 12 when the flap is followed down into a closed position.

Furthermore, two regions illustrated as a pair of rectangles in dotted lines 21 on the back face of the intermediate panel 13 may also come into contact with the edges of the CD extending through the slots 11 in the front face of the front panel 10. In order to prevent the CD from being scratching by contact with the back face of the intermediate panel, the coating may also be applied to the back face of the intermediate panel 13 in the regions identified by the rectangular boxes 21.

According to the embodiment shown in FIG. 2 a CD or other optical computer readable medium will contact the front face of the front panel 18 shown in an outline of the CD 12 and the front face of the second panel 19 indicated by the partial circle shown in FIG. 2. In addition, the edges of the CD protruding through the slots 11 in the front panel, will also contact the back face of the front panel and can be protected from scratching by coating being applied in the region identified by dashed lines 22.

It is envisaged that the coating material will be applied to each of the regions of the CD wallet described above that are contacted by the CD.

FIG. 4 illustrates yet another embodiment of a CD wallet blank comprising two panels 22 and 23 that are interconnected by a fold line 21. When assembled, the two panels 22 and 23 are folded onto each other and are fixed together by glue lines 25 to form an envelope in which a CD or alike can be placed for mailing. A top panel 26 connected to panel 23 by fold line 27 forms a flap that can be folded downwardly over the panels 22 and 23 to form a closeable wallet.

Dashed lines 28 on panels 22 and 23 represent areas of the blank that may be contacted by a CD when placed in the assembled wallet. Accordingly, it is envisaged that the coating material can be applied in the areas denoted by the dashed lines 28.

The coating material applied to the package may have any suitable composition that has a hardness less than the hardness of the polycarbonate material used for making CDs. However as a result of research undertaken, we have developed a coating material that is particularly suited to this application. Specifically, the coating material is essentially an acrylic polymeric material including silicon and wax constituents that form a mixture having suitable softness and friction properties to prevent the CD or other optical computer readable material from scratching in the event of the CD moving within the package. The table below provides a detailed breakdown of constituents of a preferred coating material.

| CONSTITUENT | MASS PERCENTAGE (%) |
|---|---|
| Multifunctional acrylic oligomers | 25-35 |
| Acrylated modified epoxy | 20-30 |
| Plasticizing resin | 1-5 |
| Hydrogen donor | 2-7 |
| Hydrogen abstracting initiator | 3-5 |
| Type 1 initiator | 1-3 |
| Acrylated silicone | 1-3 |
| Petroleum lube | 0-1 |
| Polyethylene dispersion | 1-5 |
| Petroleum wax dispersion | 10-20 |
| Optical brightener | 0-1 |
| Siloxane | 0-1 |
| Stabilizer | 0-1 |

In the instance when the coating material is to be applied using known printing techniques, the acrylated modified epoxy constituent can be substituted with a styrenated acrylic dispersion such that the coating material has a suitable viscosity.

In addition, the method for manufacturing the package preferably also includes die cutting the slots 11 for receiving the edges of the CD in a direction substantially parallel with the grain of the paper board material.

A person skilled in the art would appreciate that modifications may be made to embodiments described above without departing from the spirit and scope of the present invention.

For example, it is possible that the package for a CD or alike may be manufactured from any suitable material including thermoplastic and thermosetting resins.

1. A package for mailing CDs, DVDs or other optical computer readable mediums made of materials that include polycarbonate, the package including a panel against which a surface of the optical computer readable medium can be located to protect against damage during mailing, and wherein the panel has a polymeric coating that has been printed thereto and the coating has a hardness that is less than the hardness of the polycarbonate material from which the optical computer medium is made in order to minimise scratching the surface of the optical computer readable medium by the panel.

2. The package according to claim 1, wherein the surface of the optical computer readable medium may be either one or a combination of a readable surface or an opposite surface on which information is usually printed.

3. The package according to claim 2, wherein the coating applied to the panel includes an acrylic polymeric material.

4. The package according to claim 3, wherein the acrylic polymeric material includes constituents that influence any one or a combination of: i) the softness of the coating; and ii) friction between the coating and the optical computer readable medium.

5. The package according to claim 4, wherein the coating contains silicon.

6. The package according to claim 1, wherein the coating can be cured by ultra violet (UV) light.

7. The package according to claim 1, wherein the coating comprises the following:

| CONSTITUENT | MASS PERCENTAGE (%) |
|---|---|
| Multifunctional acrylic oligomers | ranging from 25 to 35 |
| Acrylated modified epoxy | ranging from 20 to 30 |
| Acrylated silicone | ranging from 1 to 3 |
| Petroleum wax dispersion | ranging from 10 to 20 |
| Other constituents | ranging from 44 to 12 |

8. The package according to claim 7, wherein the acrylated modified epoxy constituent of the coating is substituted with a styrenated acrylic dispersion.

9. The package according to claim 1, wherein the panel is made of a paperboard material.

10. The package according to claim 1, wherein the package consists solely of a single panel having slots and/or notches designed to receive the edges of an optical computer readable medium in order to retain the medium to the panel.

11. The package according to claim 1, wherein the package has at least two interconnected panels, whereby a readable surface of the optical computer readable medium can be located against one of the panels and the opposite side of the optical computer readable medium can be located against one of the other panels.

12. The package according to claim 11, wherein the coating is applied to the panel for contacting the readable surface of the optical computer readable medium and the panel for contacting the opposite side of the optical computer readable medium.

13. A method for making a package for mailing CDs, DVDs or other optical computer readable mediums made of materials that include polycarbonate, the package including a panel against which a surface of the optical computer readable medium can be located to protect against damage during mailing, and wherein the method includes printing a polymeric coating that when cured has a hardness that is less than the hardness of the polycarbonate material from which the optical computer readable medium is made in order to minimise scratching of the optical computer readable medium by the panel.

14. The method according to claim 13, wherein the coating includes an acrylic polymeric material.

15. The method according to claim 13, wherein the coating comprises the following:

| CONSTITUENT | MASS PERCENTAGE (%) |
|---|---|
| Multifunctional acrylic oligomers | ranging from 25 to 35 |
| Acrylated modified epoxy | ranging from 20 to 30 |
| Acrylated silicone | ranging from 1 to 3 |
| Petroleum wax dispersion | ranging from 10 to 20 |
| Other constituents | ranging from 44 to 12 |

16. The method according to claim 15, wherein the acrylated modified epoxy constituent of the coating is substituted with a styrenated acrylic dispersion.

17. The method according to claim 13, wherein the panel is made from paperboard material and the method includes cutting one or more retaining slots that can receive edges of the optical computer readable medium for holding the optical computer readable medium to the panel.

18. A polymeric coating material that can be printed onto a panel of a package for mailing CDs, DVDs or other computer readable medium made of polycarbonate material, the coating when printed and cured on the panel has a hardness that is less than the hardness of the polycarbonate material from which the optical computer readable medium is made, such that coating can minimise scratching of a surface of the optical computer readable medium.

19. The coating material according to claim 18, including an acrylic polymeric material.

20. The coating material according to claim 18, wherein the coating comprises the following:

| CONSTITUENT | MASS PERCENTAGE (%) |
|---|---|
| Multifunctional acrylic oligomers | ranging from 25 to 35 |
| Acrylated modified epoxy | ranging from 20 to 30 |
| Acrylated silicone | ranging from 1 to 3 |
| Petroleum wax dispersion | ranging from 10 to 20 |
| Other constituents | ranging from 44 to 12 |

21. The coating material according to claim 20, wherein the acrylated modified epoxy constituent of the coating is substituted with a styrenated acrylic dispersion.
